(19) United States
(12) Patent Application Publication
(10) Pub. No.: US 2014/0000350 A1
(43) Pub. Date: Jan. 2, 2014

(54) MIXTURE OF A MULTIPHASE FLUID

(71) Applicants: Guillaume Varet, Billere (FR); Djamel Nasri, Billere (FR); François Montel, Morlaas (FR); Jean-Luc Daridon, Pau (FR)

(72) Inventors: Guillaume Varet, Billere (FR); Djamel Nasri, Billere (FR); François Montel, Morlaas (FR); Jean-Luc Daridon, Pau (FR)

(73) Assignees: UNIVERSITE DE PAU ET DES PAYS DE L'ADOUR, Pau (unknown); TOTAL S.A., Courbevoie (FR)

(21) Appl. No.: 14/005,134

(22) PCT Filed: Mar. 13, 2012
(86) PCT No.: PCT/EP12/54392

§ 371 Date: Sep. 13, 2013

(30) Foreign Application Priority Data
Mar. 14, 2011 (FR) 1152061

(51) Int. Cl. B01F 13/08

(52) U.S. Cl. CPC B01F 13/08
USPC 73/64.56; 366/273; 366/144

(57) ABSTRACT

The disclosure includes a device for mixing a multiphase fluid which includes a mixing chamber; a mixing element translatable along a central axis of the mixing chamber, the distance between a point of the inner surface of the mixing chamber and the central axis being occupied between 85% and 95% by the mixing element along at least one section transverse to the central axis.

### CROSS-REFERENCE TO RELATED APPLICATIONS

This application is a National Phase Entry of International Application No. PCT/EP2012/054392, filed on Mar. 13, 2012, which claims priority to French Patent Application Serial No. 1152061, filed on Mar. 14, 2011, both of which are incorporated by reference herein.

### FIELD OF THE INVENTION

The present invention relates to a device and method for mixing a multiphase fluid, as well as a device and a method for measuring physical properties of a multiphase fluid.

### BACKGROUND

This invention is in particular applicable in oil production, for example in the extraction of heavy oils (i.e. with a high viscosity). In this context, there may be a need for PVT data (pressure, volume, and temperature) on the heavy oils under tank conditions so as to better predict their behavior during production.

It is currently impossible to make a multiphase oil-gas mixture rise from a tank under the tank's conditions. In fact, during transport, the gas dissipates in the air. Obtaining a regassed heavy oil sample is thereof an important aim for oil companies today.

The use of magnetic agitation is very widespread in traditional PVT measuring cells. In fact, for traditional fluids, which are therefore not very viscous, i.e. with a viscosity in the vicinity of 10 mPa.s (i.e. 10 milli pascal-seconds), magnetic bars are used driven by a rotary magnetic agitator outside the PVT cell. A similar solution is described in patent WO 2007/027100 with an agitator included in the piston of the PVT cell. A similar solution is also described in the article “Reservoir Fluid Analysis using PVT Express” by I. A. Kahn, K. McAndrews, J. P. Jose, and A. K. M. Jamaluddin.

However, these solutions are not suitable in the case of heavy oil because of the high viscosity (of the heavy oil phase) of the fluid to be mixed. Indeed, for a fluid with a viscosity of about 10,000 mPa.s, i.e. 10 Pa.s (e.g. for temperatures of about 0° C. to 100° C., and/or a pressure of between 1 and 200 bar), different problems can emerge, e.g. dead volumes or too weak agitating force.

At this time, a manual and time-consuming technique is therefore used to mix heavy oil+gas. This technique involves injecting the gas into the oil and waiting for homogenization of the mixture. The manipulations consist of changing the orientation of the cell in order bring gravity into play. To identify complete homogenization, the pressure prevailing in the PVT cell is observed. It decreases during the homogenization phase, then stabilizes when the gas is dissolved in the mixture. This wait can last several weeks, as heavy oils have very low diffusivity coefficients, the order of 10⁻¹⁰ m².s⁻¹. There is therefore a need for an improved method of mixing a multiphase fluid.

### SUMMARY

To that end, the invention proposes a device for mixing a multiphase fluid comprising a mixing chamber; a mixing element translatable along a central axis of the mixing chamber, the distance between a point of the inner surface of the mixing chamber and the central axis being occupied between 85% and 95% by the mixing element along at least one section transverse to the central axis. According to examples, the mixing device can comprise one or more of the following features:
the mixing element has a penetrating front profile and a penetrating rear profile;
the mixing element is spherical, cylindrical with half-spheres at the ends of the cylinder, or cylindrical with cones at the ends of the cylinder;
the mixing chamber is cylindrical;
the mixing chamber has a shape at its ends that is complementary to the mixing element;
the mixing element can be moved by magnetic driving;
the mixing element comprises a magnetic material;
the magnetic field can move along the central axis of the mixing chamber;
the magnetic field is created by at least one magnet around the mixing chamber and can move along the mixing chamber;
the magnet is made from ferrite, Neodyme Iron Boron and/or Samarium Cobalt, and/or the air gap is made from soft iron;
the device also comprises a carriage that can be moved along the central axis by a motor provided with a torque sensor, the carriage bearing the magnet;
the mixing element is made up of a sphere made from a magnetic material and a chromed coating (Ni-Cu-Ni-Cr), the sphere having a diameter comprised between 18.8 mm and 19.2 mm, a weight of 27 g, having a magnetization of 0.3 MJ.m⁻³ and an adhesion force of approximately 5.6 kg.

The invention also proposes a device for measuring physical properties of a multiphase fluid, comprising the above mixing device; means for measuring physical properties of the fluid. According to examples, the measuring device can comprise one or more of the following features:
the mixing chamber constitutes a PVT cell;
the PVT cell is situated inside a heating receptacle using a water bath with the assistance of a coolant, or using an drying oven. The invention also proposes a method for mixing a multiphase fluid using the above mixing device comprising conveying the multiphase fluid into the mixing chamber; translating the mixing element in the fluid along the central axis of the mixing chamber.

According to examples, the mixing method can comprise one or more of the following features:
the fluid comprises a viscous phase, the viscosity coefficient of which is comprised between 1 and 100 Pa.s, preferably between 1 and 60 Pa.s, preferably between 5 and 15 Pa.s;
the viscous phase is heavy oil and the fluid also comprises a gaseous phase;
the translation of the mixing element comprises backward and forward movements, preferably at a speed greater than 0.005 m.s, preferably greater than 0.01 m.s, and/or less than 0.1 m.s, preferably less than 0.03 m.s.
   The invention also proposes a method for measuring physical properties of a multiphase fluid, comprising homogenizing the fluid using the above mixing method; measuring physical properties of the homogenized fluid. The invention also proposes a method of producing hydrocarbons comprising the analysis of a hydrocarbon tank by measuring physical properties of a multiphase fluid sample from the tank according to the above measuring method.

### BRIEF DESCRIPTION OF THE DRAWINGS

Other features and advantages of the invention will appear upon reading the following detailed description of embodiments of the invention, provided solely as an example and in reference to the drawings, which show:

FIG. 1, an example of a mixing device;

FIGS. 2 to 5, an example of an assembly for creating a magnetic field;

FIG. 6, the mixing device of FIG. 1 with magnetic field lines;

FIG. 7, a mixing device with a spherical mixing element;

FIG. 8, a graph showing the force necessary to displace a spherical mixing element in a fluid as a function of its viscosity;

FIG. 9, a perspective view of the mixing device of FIG. 1 with a spherical mixing element 16; and

FIG. 10, a perspective view of a device for measuring physical properties of a multiphase fluid.

### DETAILED DESCRIPTION

The invention relates to a device for mixing a multiphase fluid. The mixing device comprises a mixing chamber and a mixing element. The mixing element is translatable along a central axis of the mixing chamber. Along at least one section of the mixing element transverse to the axis, the distance between a point of the inner surface of the mixing chamber and the central axis is occupied between 85% and 95% by the mixing element. This mixing device allows faster mixing of a multiphase fluid, in particular when one of the phases has a high viscosity.

The mixing element being translatable, it generally undergoes fewer stresses than in a system with a rotary agitator. In this way, the device is adapted to a multiphase fluid comprising a viscous phase, as the device requires less force for the mobility of the mixing element. The mixing element can in particular have a penetrating front profile and a penetrating rear profile. This further decreases the stresses undergone during mixing and, as a result, the force required to perform the mixing. A penetrating profile designates a monotonous (decreasing) section of the mixing element along the central axis, starting from the central section of the mixer toward the front and back exteriors. In this way, each half (front and rear) of the mixer can have an apex.

In order to ensure mixing with this translational movement, the distance between a point of the inner surface of the mixing chamber and the central axis is occupied between 85% and 95% by the mixing element along at least one section transverse to the axis. In other words, during use of the mixing device, i.e. when the mixing chamber contains the multiphase fluid and the mixing element is in motion, there is at least one point P_{S} of the inner surface of the chamber projected orthogonally on the central axis at a point P_{A}, the distance between P_{S} and P_{A} being occupied at least 85% and at most 95% by the mixing element. In this way, at least at one moment of the movement, at least one segment joining a point of the inner surface and the axis (that joining P_{S} to P_{A}) is made up between 85% and 95% of the mixing element.

The mixing element therefore has a section close to that of the mixing chamber at such a point P_{S}, which involves a small exchange surface. Having a small exchange surface allows rolling of the multiphase fluid, which allows a better transfer of matter, and therefore a more homogenous mixture. This rolling is even more important when the fluid comprises a viscous phase.

The fact that the proportion of the mixer in the distance is comprised between 85% and 95% makes it possible to ensure good mixing while leaving sufficient mobility for the mixing element. In fact, increasing this ratio causes an increase in the viscous force, which is even more pronounced when the fluid comprises a viscous phase. Thus, at the mixing element, the distance from any point of the surface to the central axis is preferably always occupied by the mixing element in a proportion smaller than 95%.

The mixing device can therefore be used for a mixing method comprising conveying the multiphase fluid into the mixing chamber and translating the mixing element in the fluid along the central axis of the mixing chamber. Such a method ensures homogenous and fast mixing of the multiphase fluid. The fluid can comprise a viscous phase, the viscosity coefficient of which is comprised between 1 and 100 Pa.s, preferably between 1 and 60 Pa.s, preferably between 5 and 15 Pa.s. For example, the viscous phase is heavy oil and the fluid also comprises a gaseous phase. The mixing device then makes it possible to obtain a homogenous heavy oil+gas mixture. In such a case, the device is particularly effective in that it ensures a fast and effective homogenization of the mixture between oil and gas. However, all types of very viscous products can be mixed using the mixing device.

The translation of the mixing element can comprise backward and forward movements, e.g. until the mixture is homogenized. The method can comprise detecting the homogenization, for example by the user (e.g. using his experience), or by pressure and/or viscosity measurements of the mixture. For example, the pressure can be measured by a specific sensor, and/or the viscosity can be measured by measuring an intensity of a motorization of the mixing device, as will be exemplified below in reference to FIG. 9. For example, the mixture can be detected as being homogenous, when the derivative of the pressure or viscosity evolution becomes close to zero (below a predetermined threshold). The speed of the mixing element can depend on the viscosity of a viscous phase of the multiphase fluid (e.g. an oil phase). For example, in the case of an oil, the more viscous the oil, the more slowly the mixing element can go. This speed can be determined arbitrarily, e.g. as a function of the user's experience. In any case, the speed can be greater than 0.005 m.s, preferably than 0.01 m.s, and/or less than 0.1 m.s, preferably than 0.03 m.s. It should be noted that the device can comprise means for calculating the speed, and/or modifying/imposing the speed, manually or automatically. The method can thus comprise steps for calculating the speed, and/or for modifying/imposing a speed. Such a movement allows fast and homogenous mixing, while avoiding the creation of emulsions or foam due to turbulence, the speed being controlled enough for that. The gas then dissolves well in the fluid. In fact, the mixing device and mixing method above allow good homogenization without agitation. However, during agitation, emulsion may appear in the case of a liquid+liquid fluid or “foam” in the case of a liquid+gas fluid, which hinders the homogenization. For example in the case of a gas+oil fluid, stable gas bubbles may be created in the oil. This creation of gas bubbles hinders the homogenization and slows it down.

In the case of a gas+oil fluid, the time and appearance of the drop in pressure can also make it possible to obtain the gas diffusion coefficient in the oil and the behavior of the oil. The evolution of the viscosity can also provide information on the behavior of the oil. The device thus makes it possible to obtain a heavy oil+gas sample that is correctly homogenized as quickly as possible, and potentially to know the properties thereof. It is then possible to perform measurements of physical properties on the homogenized multiphase fluid.

For example, the mixing device can be comprised in a device for measuring physical properties of a multiphase fluid also comprising means for measuring physical properties of the fluid. It is thus possible to measure physical properties of the fluid under tank conditions, i.e. with the different homogenized phases. In particular, the mixing chamber can be a PVT cell. Such a measuring device is particularly useful in the context of a hydrocarbon production method that comprises analyzing a hydrocarbon tank by measuring physical properties of a multiphase fluid sample from the tank. In fact, as indicated above, it is difficult to recover the sample under the tank conditions because the gas dissipates. The mixing device makes it possible to mix the sample to then measure the physical properties thereof, traditionally to perform PVT measurements (Pressure, Volume, Temperature).

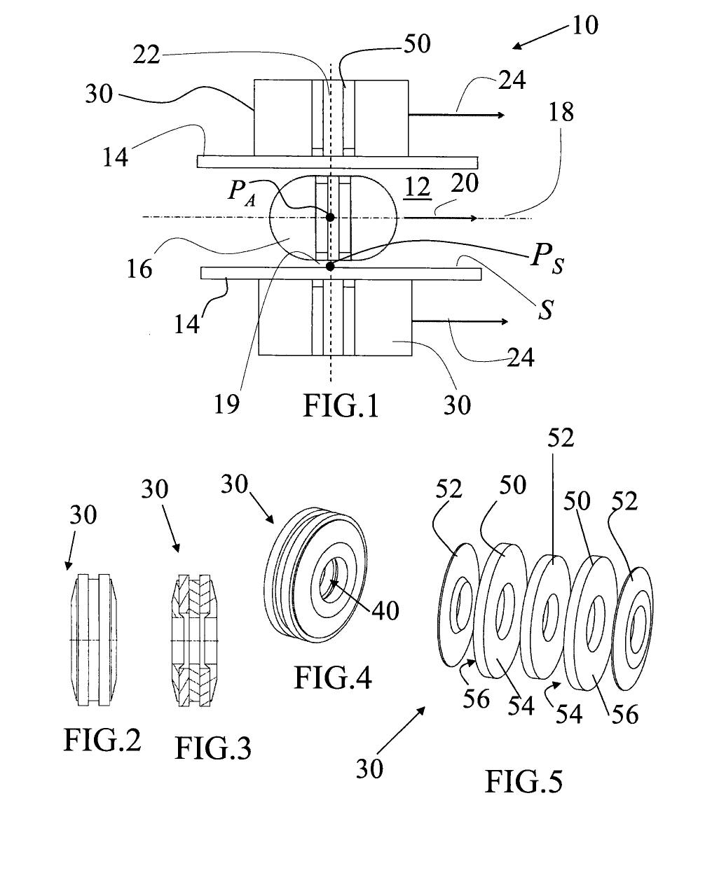

Examples of the mixing device and the measuring device will now be discussed in reference to the figures. FIG. 1 shows an example of the mixing device.

In this example, the mixing device 10 is shown partially and in longitudinal cross-section, only a segment of the mixing chamber 14 being illustrated. The mixing chamber 14 is made up of a wall that defines an inner volume 12. The mixing chamber 14 therefore comprises an inner surface S that is the surface of the wall opposite the inner volume 12. The mixing chamber 14 is thus adapted to receive the multiphase fluid in the inner volume 12 so that the latter is mixed. To that end, the mixing device 10 comprises the mixing element 16. As shown in FIG. 1, the mixing element 16 is translatable along the central axis 18 of the mixing chamber 14. This movement is shown by the arrow 20. FIG. 1 shows a section 22 of the mixing element 16 transverse to the central axis 18.

Along section 22, the distance between a point P_{S} of the inner surface S and the central axis 18 is occupied between 85 and 95% by the mixing element 16. In other words, if one considers the point P_{A} resulting from the orthogonal projection of P_{S} on the axis 18, the distance between P_{S} and P_{A} is occupied between 85 and 95% by the mixing element 16 (FIG. 1, illustrative, does not necessarily reproduce this proportion precisely). As previously explained, the mixing device 10 makes it possible to obtain a homogenous oil-gas mixture more quickly. In fact, the multiphase fluid is rolled and therefore mixed in the interstice 19 made up of the space between the mixing element 16 and the inner space S. The mixing quality is improved relative to the manual method of the prior art because there is no dead volume in the mixture. In other words, the mixture is more homogenous.

The interstice 19 corresponds to the largest transverse section of the mixing element 16 (i.e. the section occupying the most space inside the mixing chamber 14). In that section, the greatest distance between a point of the inner surface of the mixing chamber 14 and the central axis 18 is occupied between 85% and 95% by the mixing element 16 along at least one section 22 transverse to the central axis 18. In other words, at the mixing element 16, along the central axis 18, at most between 85 and 95% of the distance is occupied by the mixing element 16.

In the example of FIG. 1, the distance between the inner surface S and the central axis 18 along the section 22 is occupied everywhere between 85 and 95% by the mixing element 16. In other words, all of the points belonging both to the inner surface S and the section 22 are at a distance from the central axis 18 occupied between 85 and 95% by the mixing element 16, i.e. the mixing element 16 therefore occupies between 85 and 95% of all of the segments joining the axis 18 and the inner surface S. This extends the rolling to the entire circumference of the mixing element 16 and thereby accelerates the mixing.

The above property is in particular verified if the mixing chamber 14 is generally in a cylindrical shape with radius R and the mixing element 16 has at least one section transverse to the central axis 18 with radius r such that r=k*R, with k comprised between 85% and 95%, as is the case in the example of FIG. 1. In fact, in the example of FIG. 1, the mixing element 16 is cylindrical with half-spheres at the ends of the cylinder. In the case at hand, the property is verified at least for each section taken in the cylindrical portion of the mixing element 16. In the case of a spherical mixing element 16, the property is verified at least for the (largest) central section. In any case, the property is at least verified for the largest transverse section of the mixing element 16. Other forms of the mixing element 16 verify the above property, for example if the mixing element 16 is spherical (as in the examples of FIGS. 7 to 10 discussed hereafter) or cylindrical with cones at the ends of the cylinder, or simple cylindrical or conical.

The spherical shapes, with half-spheres at the ends of the cylinder, and cylindrical with cones at the ends of the cylinder, have the additional advantage of offering a penetrating profile, as previously discussed. This decreases the stresses undergone by the mixing element 16. The sphere is in particular adapted for the mixing element 16 so as to ensure good penetration in the fluid.

In any case, the mixing chamber 14 can have a shape at its ends that is complementary to the mixing element 16 (the ends are not shown in FIG. 1). For example, if the mixing element 16 is spherical or cylindrical with half-spheres at the ends of the cylinder, the mixing chamber 14 can have a half-spherical base at its ends. This avoids dead volumes, since the mixing element 16 arrives near the ends during mixing.

The mixing element 16 can be movable by magnetic driving. This leaves more space for the multiphase fluid in the mixing chamber 14 by avoiding adding mechanical driving means therein. The mixing device 10 is also easier to make. In the example of FIG. 1, the mixing element 16 comprises a magnetic material, the mixing element 16 being driven along the central axis 18 by a mobile magnetic field. In particular, the magnetic field is created by at least one magnet 50 around the mixing chamber 14 and can move along the mixing chamber 14. The magnet 50 is secured to an assembly 30 for creating a magnetic field in translational movement along the axis 18, as shown in FIG. 1 by arrows 24. The mobile magnetic field can also be created by solenoids suitably placed around the mixing chamber 14. Creating the mobile magnetic field using magnetic materials moving linearly makes it possible to greatly decrease the electricity consumption of the mixing device 10. This is even more optimal from an energy perspective when the mixing method lasts several hours.

The mixing chamber 14 is then advantageously made from a non-magnetic material so as to avoid magnetic interference, preferably non-magnetic stainless steel (e.g. INOX 316L) or aluminum. The wall of the mixing chamber 14 can have a limited thickness, preferably smaller than 10 mm, or smaller than 5 mm, advantageously in the vicinity of 3 mm. This allows energy savings, the magnetic field created inside the chamber 14 being less disrupted.

FIGS. 2 to 5 respectively show a full profile view, a profile section view, a perspective view, and an exploded view of the assembly 30 for creating a magnetic field. The assembly 30 comprises two magnets 50 that are separated and surrounded by seals 52 forming an “air gap.” The assembly 30 has a central passage 40 allowing it to slide around the mixing chamber 14. In the example, the two magnets 50 have opposite orientations. For example, the faces 54 are the north pole and the faces 56 are the south pole of the magnets 50, or vice versa. The magnets 50 can be made from ferrite, Neodyme Iron Boron, and/or Samarium Cobalt. The air gap can be made from soft iron, which makes it possible to concentrate the magnetic field. The magnets 50 and the seals 52 assume, in the example, the shape of a disk pierced in its center. The assembly 30 therefore assumes the shape of a ring. Such a shape allows the creation of a stable magnetic field inside the mixing chamber 14. The magnetic field can move by sliding the ring-shaped assembly 30 around the mixing chamber 14. The magnetic field therefore drives the mixing element 16 so as to ensure the mixing. In fact, the mixing element 16 can also contain magnetic material, which can be the same as that of the magnets 50 or a different material. For example, it can be ferrite, Neodyme Iron Boron, and/or Samarium Cobalt.

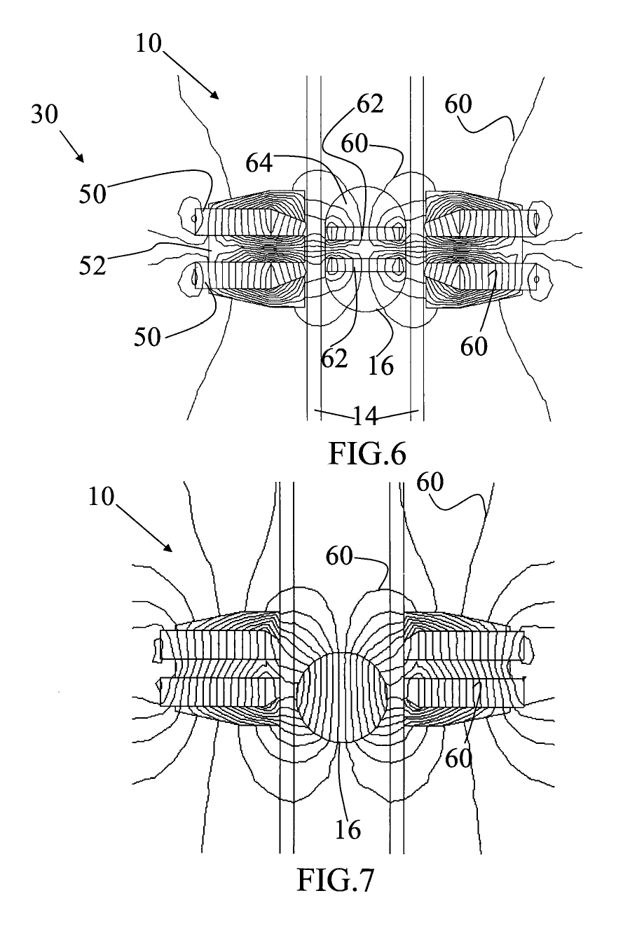

FIG. 6 shows the mixing device 10 of the example of FIG. 1, in which field lines 60 of the magnetic field created are shown. In this example, the mixing element 16 comprises two magnets 62 in the air gap 64. Typically, if the north faces of the two magnets 50 are opposite one another in the assembly 30, the south faces of the magnets 62 are accordingly opposite one another in the mixing element 16, and vice versa. The field lines 60 in this configuration are substantially parallel to the central axis through the magnets 62 of the mixing element 16, and therefore parallel to the direction of translational movement of the mixing element 16. The magnetic field is therefore configured for an optimal magnetic driving force.

FIG. 7 shows the mixing device 10 with a mixing element 16 different from that of the example of FIG. 1. In FIG. 7, the mixing element 16 is spherical. In this example, the mixing element 16 may consist of a sphere of magnetic material and a chromed coating (Ni-Cu-Ni-Cr). The sphere can have a diameter between 18.9 mm and 19.1 mm, a weight of about 25 to 29 g, preferably 27 g. The sphere can have a magnetization of the order of 0.2 to 0.4 MJ.m-3, preferably 0.3 MJ.m-3 and an adhesion strength of the order of 5.4 to 5.8 kg, preferably 5.6 kg. As in the previous example, in this configuration the field lines 60 are substantially parallel to the central axis at the mixing element 16.

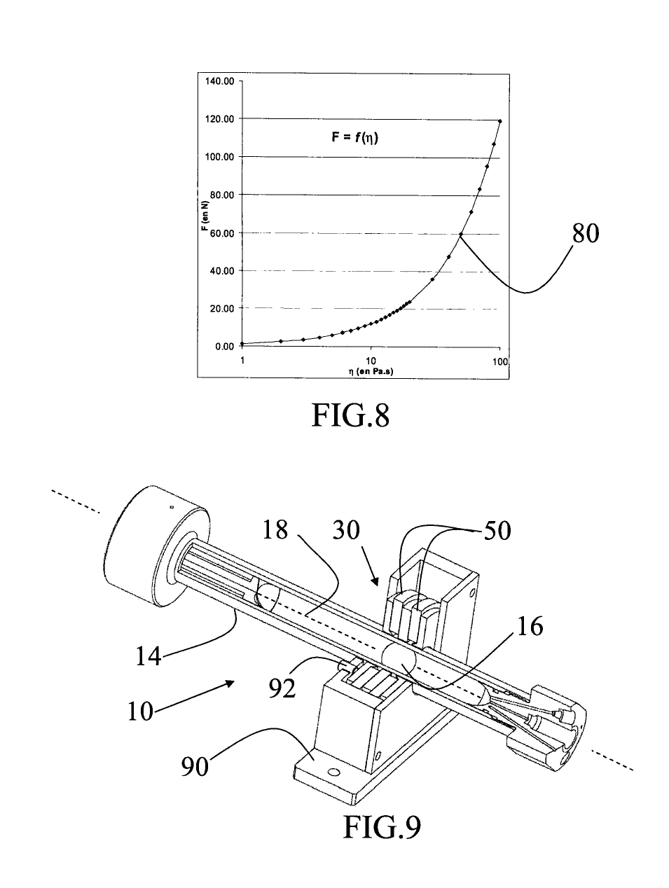

Using software with finite element calculation, we can evaluate the induced magnetic field and thus determine the magnetic force that is exerted on the mixing element 16. With the configuration of FIG. 7, magnetic forces of the order of 60 N are obtained. However, through calculations based on fluid mechanics, we can in a known manner assess the resistance force of a fluid on the spherical mixing element 16 for a viscosity range corresponding to that of heavy oils. This produces a graph like FIG. 8, which shows a curve 80 illustrating the force required (y axis) to move a spherical mixing element 16 in a fluid as a function of its viscosity (x axis).

It is observed that the forces obtained with the configuration of FIG. 7 are equivalent to those necessary for the movement of the spherical mixing element 16 in a fluid of a viscosity of up to 50,000 mPa.s, e.g. at temperatures of 0° C. to 100° C. and/or a pressure of between 1 and 200 bar. The configuration of FIG. 7 is particularly effective in the case of heavy oils, whereof the viscosity is of the order of 10,000 mPa.s.

We will now refer to FIG. 9, which shows a perspective view of the mixing device 10 of FIG. 1, with a spherical mixing element 16. In the figure, the mixing device 10 is opened to better show its different components. In this example, the mixing device 10 further includes a carriage 90 movable along the central axis 18. The carriage 90 carries the magnets 50. The assembly 30 is typically attached to the carriage, for example using screws 92. The carriage 90 may be controlled in translation by means of a motor-wheels-belts, gears-racks-motor, or motor-endless screw-nut system. The translation control can be calculated as a function of the pressure within the mixing chamber 14, in which case it comprises a pressure sensor. This makes it possible to automate the multiphase fluid mixing process. The motor can be provided with a force sensor. The force required for the displacement being related to the viscosity of the fluid, a force sensor such as a torque sensor connected to the motor is used to inform the fluid viscosity.

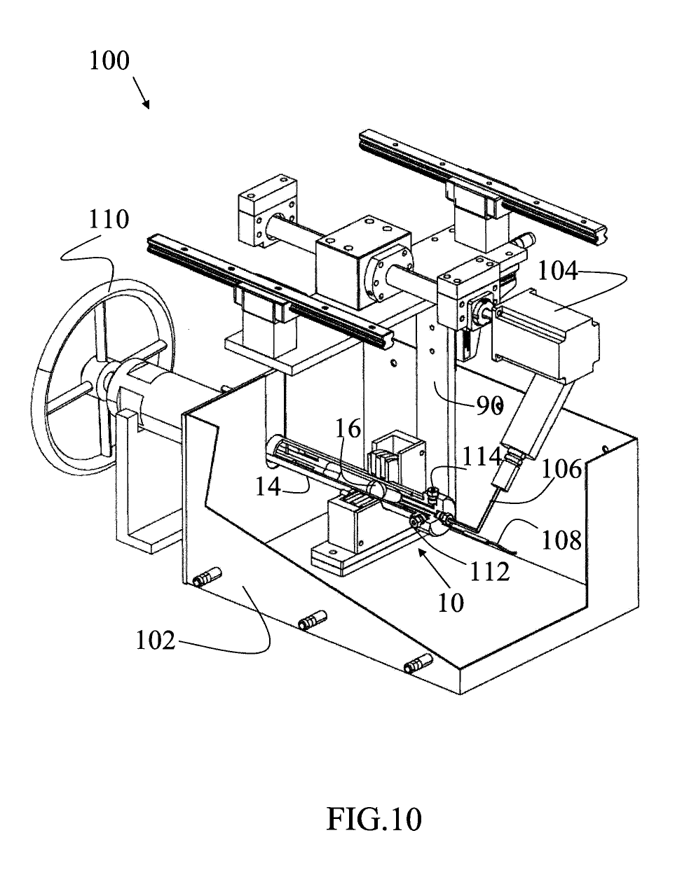

We will now refer to FIG. 10, which shows a perspective view of a device 100 for measuring physical properties of a multiphase fluid comprising the mixing device 10 of FIG. 9 in additional means for measuring physical properties of the fluid (typically PVT), the mixing chamber 14 being a PVT cell. In the figure, the measuring device 100 and the mixing device 10 are opened in order to better show their different components. The measuring device 100 is particularly suitable for performing PVT measurements on multiphase fluid samples (heavy oil+gas). The PVT cell 14 is situated inside a heating receptacle 102. The heating can be done by water bath using a coolant, or by drying oven (e.g. the receptacle constitutes a drying oven). Traditional PVT cells have means for adjusting the temperature, generally a heating resistance as described in document JP7167767A. Using a receptacle 102 immersed in an adapted coolant, for example Galden HT 200, or heating using a drying oven, makes it possible to obtain heating without such a resistance and thus to save on the volume of the receptacle 102 for the carriage 90.

FIG. 10 shows the carriage 90, as well as the motor 104 controlling the translation of the carriage 90. The measuring device 100 comprises an oil inlet 112 and a gas inlet 114 for conveying multiphase fluid (biphase in the case at hand) into the PVT cell 14. The measuring device 100 also comprises a handling system 110 to act on the dimension of the inner volume of the PVT cell, as well as a pressure 106 and temperature 108 sensor. The measuring device 100 thus makes it possible to perform PVT measurements after having conveyed a multiphase fluid into the PVT cell and having mixed it using the mixing device 10.

Tests have been performed on a prototype of the device 100 with silicone oils with viscosities similar to those of heavy oils. A test was in particular done with an oil at 10,000 mPa.s and another with an oil at 60,000 mPas. The tests were carried out at atmospheric pressure (0.1 MPa) and temperature (25° C.). The tests were conclusive, i.e. the multiphase liquid was thoroughly mixed and the measurements were stable. Tests with the same silicone oils for different pressures (0.1 to 20 MPa) were also performed and have also led to conclusive results.

1. A device for mixing a multiphase fluid, the mixing device comprising:
a mixing chamber; and
a mixer translatable along a central axis of the mixing chamber, the distance between a point of the inner surface of the mixing chamber and the central axis being occupied between 85% and 95% by the mixer along at least one section transverse to the central axis.

2. The mixing device according to claim 1, wherein the mixer has a penetrating front profile and a penetrating rear profile.

3. The mixing device according to claim 2, wherein the mixer is at least one of: spherical, cylindrical with half-spheres at the ends of the cylinder, or cylindrical with cones at the ends of the cylinder.

4. The mixing device element according to claim 1, wherein the mixing chamber is cylindrical and has a shape at its ends that is complementary to the mixer.

5. The mixing device according to claim 1, wherein the mixer can be moved by magnetic driving.

6. The mixing device according to claim 5, wherein the mixer comprises a magnetic material, the magnetic field being created by at least one magnet adjacent ground the mixing chamber and movable along the mixing chamber.

7. The mixing device according to claim 6, wherein the magnet is made at least one of: from ferrite, Neodyme Iron Boron and/or Samarium Cobalt, and/or the air gap is made from soft iron.

8. The mixing device according to claim 6, also comprising a carriage that can be moved along the central axis by a motor provided with a torque sensor, the carriage bearing the magnet.

9. The mixing device according to claim 1, further comprising:
means a sensor operably measuring physical properties of the multiphase fluid, the mixing chamber comprising a PVT cell, the PCT cell and sensor assisting in measuring physical properties of the multiphase fluid.

10. The mixing device according to claim 9, wherein the PVT cell is situated inside a heating receptacle using one of: (a) a water bath with the assistance of a coolant, or (b) a drying oven.

11. A method for mixing a multiphase fluid, the method comprising:
conveying the multiphase fluid into a mixing chamber; and
translating a mixer the in the fluid along the central axis of the mixing chamber, and a distance between a point of the inner surface of the mixing chamber and the central axis being occupied between 85% and 95% by the mixer along at least one section transverse to the central axis.

12. The mixing method according to claim 11, wherein the fluid comprises a viscous phase, the viscosity coefficient of which is comprised between 1 and 100 Pa.s.

13. The mixing method according to claim 12, wherein the viscous phase is heavy oil and the fluid also comprises a gaseous phase.

14. The mixing method according to claim 13, wherein the translation of the mixer comprises backward and forward movements, at a speed greater than 0.005 m.s.

15. A method for measuring physical properties of a multiphase fluid, the method comprising:
homogenizing the multiphase fluid using a mixing method that comprises:
conveying the multiphase fluid into the mixing chamber;
moving a mixer in the multiphase fluid along the central axis of the mixing chamber; and
measuring physical properties of the homogenized fluid.

16. The method of claim 15, producing further comprising analyzing a hydrocarbon tank by measuring physical properties of a multiphase fluid sample from the tank, and producing hydrocarbons from the tank.
